(19) United States
(12) Patent Application Publication
(10) Pub. No.: US 2006/0267765 A1
(43) Pub. Date: Nov. 30, 2006

(54) RFID logging of media in a media roll and method

(76) Inventor: Bruce McKay Morton, Lake Stevens, WA (US)

Correspondence Address: Orum & Roth LLC, 53 West Jackson Blvd., Chicago, IL, 60604, US

(21) Appl. No.: 11/139,843

(22) Filed: May 27, 2005

(51) Int. Cl. G08B 13/14

(52) U.S. Cl. 340/572.1

(57) ABSTRACT

A label printer embedded RFID tag reader/writer and the media roll with a rewritable RFID tag affixed to the media are used to keep a running tally of the number of remaining labels on the roll and record the tally onto the RFID tag. The printer “odometer” keeps track of the number of labels remaining on a media roll or for receipt tape, the remaining length of the tape. The printer sends a signal to the rewritable RFID tag on the printer media with accurate information about the remaining media.

### BACKGROUND OF THE INVENTION

1. Field of the Invention

The present invention relates to a label printer. More specifically it relates to an RFID reader/writer and a media roll with a rewritable RFID tag that can keep track of the number of remaining labels on the roll.

2. Description of Related Art

Printable labels generally come in a roll. The roll of label media has a finite number of labels on it. To reduce or eliminate downtime (of both staff and machinery) and to not waste any labels, it is important to know the number of labels remaining on the roll. An accurate count of the number of remaining labels allows a user to prepare for changing the label roll at the appropriate time. Prior art printers have a counter that keeps track of the number of labels printed.

Some user applications require that the label media be changed before the roll is depleted. This may occur when a number of first labels need to be printed and then a number of second labels need to be printed where the two labels require different label media. Prior art label printers cannot accurately determine the number of labels remaining on a media roll that has been changed prior to being depleted. Prior art label printers estimate the number of remaining media by measuring the roll diameter, as labels are used the diameter of the media roll decreases. However, this method does not provide an accurate count of the number of remaining labels. Alternatively, a user can manually enter label count into the printer each time the label roll is changed. This requires that the user maintain records on the number of remaining labels and manually enter this information into the printer each time a roll of label media is replaced.

There is a need for an automated system that keeps track of the number of labels remaining even when media rolls are switched out before the roll is depleted.

### SUMMARY OF THE INVENTION

The inventive device is the label printer with an RFID reader/writer and a media roll with a rewritable RFID tag. The printer “odometer” keeps track of the number of labels remaining on a media roll. The printer sends a signal to the rewritable RFID tag on the printer media with information about the remaining labels.

A label printer embedded RFID tag reader/writer and the media roll with a rewritable RFID tag affixed to the media are used to keep a running tally of the number of remaining labels on the roll and record the tally onto the RFID tag.

When a roll of media is manufactured an RFID tag can be affixed to the media, generally on the media hub. The RFID tag contains information about the total number of labels on the roll. When the media is loaded onto a printer, the printer queries the roll to determine the number of labels remaining. When each label is printed, the printer's RFID writer decrements the label count on the rolls and writes this information to the RFID tag. This feature allows the printer to always report the correct number of remaining labels on the roll, even if the printer is loaded with a partially full roll. When a partially used roll of media is removed from the printer the RFID tag “remembers” the number of labels remaining. When the roll is again loaded onto the printer, the printer RFID reader interrogates the RFID tag for the number of labels remaining.

Alternatively, in the case of a receipt printer, the length of the receipt media is initially written onto the RFID tag in the media hub. As receipts are printed the printer keep keeps track of the remaining length of the roll. After each receipt is printed, the length of the printed receipt is subtracted from the stored value on the RFID tag and a new value is stored.

### BRIEF DESCRIPTION OF THE FIGURES

FIG. 1 is schematic representation of the media and printer.

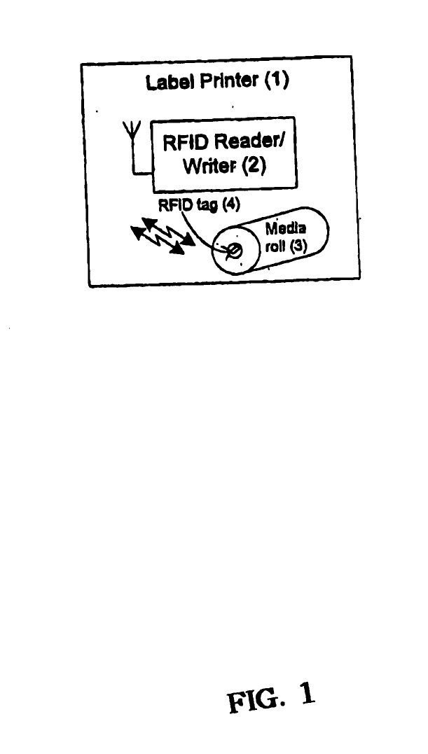

FIG. 2 is a block diagram of the inventive method.

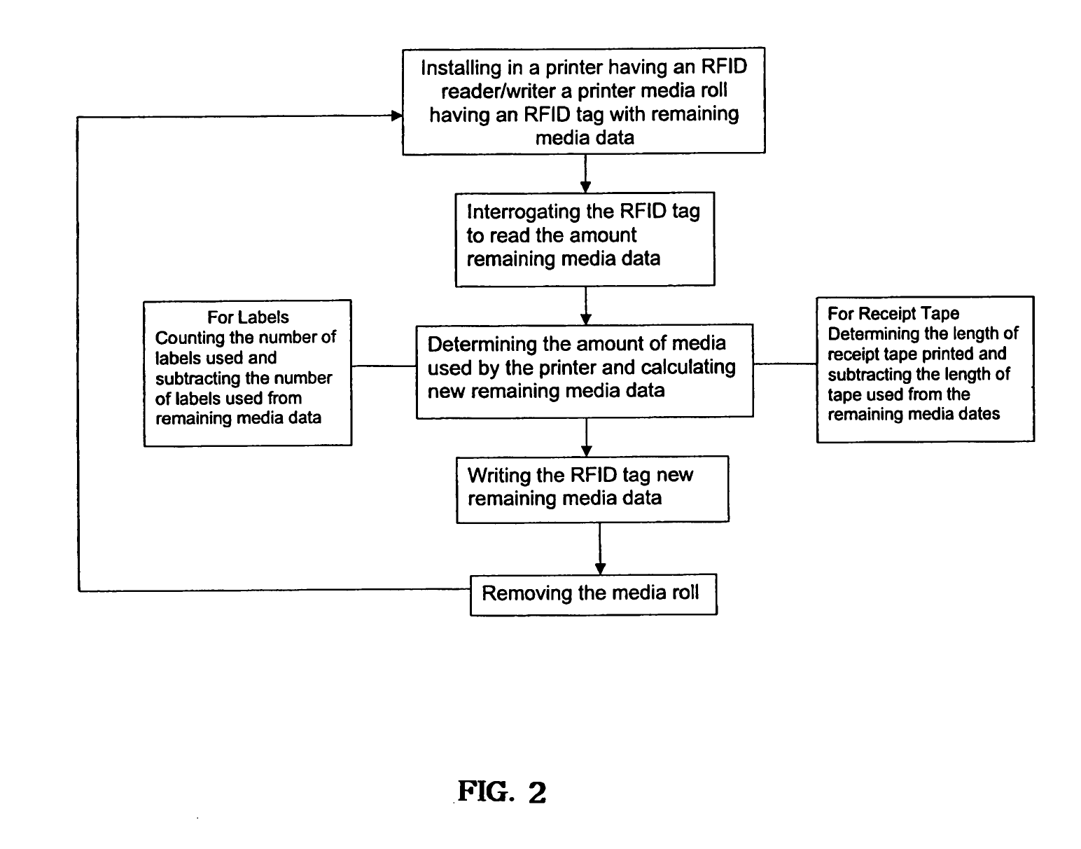

### DETAILED DESCRIPTION OF THE INVENTION

The inventive device is the label printer 1 with an RFID reader/writer 2 and a media roll 3 with a rewritable RFID tag 4. The printer “odometer” keeps track of the number of labels remaining on a media roll 3. The printer 1 sends a signal to the rewritable RFID tag 4 on the printer media 3 with information about the remaining labels.

A label printer 1 embedded RFID tag reader/writer 2 and the media roll 3 with a rewritable RFID tag 4 affixed to the media 3 are used to keep a running tally of the number of remaining labels on the roll and record the tally onto the RFID tag 4.

When a roll 3 of media is manufactured an RFID tag 4 can be affixed to the media, generally on the media hub. The RFID tag 4 contains information about the total number of labels on the roll 3. When the media 3 is loaded onto a printer 1, the printer 1 queries the RFID tag 4 on the roll 3 to determine the number of labels remaining. When each label is printed, the printer 1 decrements the label count on the roll 3. The RFID reader/writer 2 then writes this information to the RFID tag 4. This feature allows the printer 1 to always report the correct number of remaining labels on the roll 3, even if the printer 1 is loaded with a partially full roll 3. When a partially used roll 3 of media is removed from the printer 1 the RFID tag 4 “remembers” the number of labels remaining. When the roll 3 is again loaded onto the printer 1, the printer RFID reader 2 interrogates the RFID tag 4 for the number of labels remaining. The RFID writer 2 can write to the tag 4 each time a label is printed, each time a set number of labels have printed, each time a specified period of time has elapsed, at a specified period after a print job, at some other regular interval or based on some other criteria. The regular interval may be based on print time, elapsed time, number or amount of media printed or some other criteria.

Alternatively, in the case of a receipt printer 1, the length of the receipt media is initially written onto the RFID tag 4 in the media hub. As receipts are printed the printer 1 keeps track of the remaining length of the roll 3. After each receipt is printed, the length of the printed receipt is subtracted from the stored value on the RFID tag 4 and a new value is stored.

1. A method of keeping track of the amount of remaining printer media comprising the steps of:
a. obtaining a printer media roll having an RFID tag affixed to the media roll, said RFID tag containing Information about an amount of media on the media roll,
b. Installing the printer media roll on a printer having an RFID reader/writer,
c. Interrogating by the printer the RFID tag to read the amount of remaining media on the roll,
d. determining the amount of media that is used by the printer, and
e. writing by the printer to the RFID tag a new amount of remaining media on the roll.

2. The method of claim 1 wherein the media is labels and the amount of media remaining is a number of labels, further comprising the steps of counting the number of labels printed and subtracting this number from the number of labels to calculate the new amount of remaining media.

3. The method of claim 1 wherein the media is receipt tape, and the amount of media remaining is a length of tape, further comprising the steps of determining the length of receipt tape printed and subtracting the amount of tape printed from the length of tape to calculate the new amount of remaining media.

4. The method of claim 1 further comprising the steps of repeating steps d-e.

5. The method of claim 1 further comprising the steps of:
removing the media roll from the printer, and after a period of time repeating steps b-e.

6. The method of claim 2 further comprising the steps of repeating steps d-e.

7. The method of claim 2 further comprising the steps of:
removing the media roll from the printer, and after a period of time repeating steps b-e.

8. The method of claim 3 further comprising the steps of repeating steps d-e.

9. The method of claim 3 further comprising the steps of:
removing the media roll from the printer, and after a period of time repeating steps b-e.

10. The method of claim 5 further comprising the steps of
obtaining a second printer media roll, having a second RFID tag affixed to the second media roll, said second RFID tag containing information about the amount of media on the second media roll,
installing the second printer media roll on the printer,
interrogating by the printer the second RFID tag to read the amount of remaining media on the second roll,
determining the amount of media remaining on the second roll,
writing by the printer to the second RFID tag the amount of remaining media on the second roll,
wherein the steps relating to the second printer media roll are undertaken before steps b-e are repeated for the media roll.

11. The method of claim 7 further comprising the steps of
obtaining a second printer media roll, having a second RFID tag affixed to the second media roll, said second RFID tag containing information about the amount of media on the second media roll,
installing the second printer media roll on the printer,
interrogating by the printer the second RFID tag to read the amount of remaining media on the second roll,
determining the amount of media remaining on the second roll,
writing by the printer to the second RFID tag the amount of remaining media on the second roll,
wherein the steps relating to the second printer media roll are undertaken before steps b-e are repeated for the media roll.

12. The method of claim 9 further comprising the steps of
obtaining a second printer media roll, having a second RFID tag affixed to the second media roll, said second RFID tag containing information about the amount of media on the second media roll,
installing the second printer media roll on the printer,
interrogating by the printer the second RFID tag to read the amount of remaining media on the second roll,
determining the amount of media remaining on the second roll,
writing by the printer to the second RFID tag the amount of remaining media on the second roll,
wherein the steps relating to the second printer media roll are undertaken before steps b-e are repeated for the media roll.

13. The method of claim 12 wherein the second media is receipt tape, and the amount of media remaining is a length of tape, further comprising the steps of determining the length of receipt tape printed and subtracting the amount of tape printed from the length of tape to calculate the new amount of remaining media.

14. The method of claim 1 wherein the amount of remaining media is written to the RFID tag after each print task.

15. The method of claim 1 wherein the amount of remaining media is written to the RFID tag at regular intervals.

16. The method of claim 1 further comprising the step of ascertaining the amount of remaining media by a technician.

17. A system for logging the remaining media on a media roll comprising:
a printer having an RFID reader/writer and a counter,
a media roll installed on the printer, said media roll having an attached RFID tag containing information about an amount of media remaining on the media roll,
wherein the information about amount of remaining media is rewritten by the printer each time media is printed or at regular intervals.

18. The system of claim 17 wherein the counter is adapted to determine an amount of media used and a new amount of remaining media is calculated.

19. The system of claim 18 wherein the rewritten information about the amount of remaining media is the new amount of remaining media.

20. The system of claim 18 wherein the media roll is a partial roll of media.
